(19) United States
(12) Patent Application Publication
(10) Pub. No.: US 2014/0220940 A1
(43) Pub. Date: Aug. 7, 2014

(54) COMMUNICATION SYSTEM WITH CALL MANAGEMENT MECHANISM AND METHOD OF OPERATION THEREOF

(71) Applicant: SAMSUNG ELECTRONICS CO., LTD., GYEONGGI-DO (KR)

(72) Inventor: Michael Baisuck, San Jose, CA (US)

(73) Assignee: SAMSUNG ELECTRONICS CO., LTD., GYEONGGI-DO (KR)

(21) Appl. No.: 13/759,624

(22) Filed: Feb. 5, 2013

(51) Int. Cl. H04W 4/12

(52) U.S. Cl. CPC H04W 4/12
USPC 455/412.1

(57) ABSTRACT

A method for managing communication includes: assembling an established group using a control unit; provisioning a message option attributed to the established group; generating an announcement screen for displaying on a display device; and providing an outgoing message and response option, by ignoring the announcement screen, based on the message option attributed to the established group.

### TECHNICAL FIELD

An embodiment of the present invention relates generally to a communication system, and more particularly to a system for managing communication.

### BACKGROUND

Wireless communications provide nearly ubiquitous communication connectivity in the world. A portion of the population of every nation possess a mobile communication device. The technological sophistication of users of mobile communication devices ranges from those who merely want to use their mobile communication device to access plain old telephone service (POTS) to those who have high speed data service plans and use their mobile communication device to access the Internet.

Every user of the mobile communication device can experience times when it is not practical to answer an incoming call. In these instances the mobile communication device can activate a self-answering process and can invoke a recorded message explaining that the user is unavailable and offer the opportunity to leave a message that the user of the mobile communication device can retrieve at a later time. Quite often this process is problematic. Callers may be uncomfortable leaving a message, the user might not notice there is a pending message, or the message can be an emergency message from a family member that isn't noticed.

Thus, a need still remains for a communication system with call management mechanism. In view of the world-wide reliance on mobile communication and the growing expectation that every call can be accommodated immediately, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a method of operation of a communication system including: assembling an established group with a control unit; provisioning a message option attributed to the established group; generating an announcement screen for displaying on a display device; and providing an outgoing message and response option, by ignoring the announcement screen, based on the message option attributed to the established group.

An embodiment of the present invention provides a method of operation of a communication system including: assembling an established group with a control unit including compiling a contact list for determining the established group; provisioning a message option attributed to the established group including activating a group select pull-down for designating the contact list as one of blocked, business associates, special, and friends; generating an announcement screen for displaying on a display device; and providing an outgoing message and response option, by ignoring the announcement screen, based on the message option attributed to the established group.

An embodiment of the present invention provides a communication system, including: a control unit configured to assemble an established group; a storage unit, coupled to the control unit, is configured to store a message option attributed to the established group; a display interface, coupled to the control unit, is configured to generate an announcement screen displayed on a display device; and a communication unit, coupled to the control unit, is configured to provide an outgoing message and response option based on the message option attributed to the established group.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is a communication system with call management mechanism in an embodiment of the present invention.

FIG. 2 is an exemplary block diagram of the communication system with call management mechanism in an embodiment of the present invention.

FIG. 3 is an example of the display device having a contact list panel.

FIG. 4 is an example of the display device having an incoming call display.

FIG. 5 is an example of the display device having an option overlay panel accessed through the incoming call display of FIG. 4.

FIG. 6 is an example of the display device having a call log overlay for processing a call log.

FIG. 7 is an example of the first device, having the display device, in a response configuration process.

FIG. 8 is a flow chart of an exemplary operation of the communication system of FIG. 1.

FIG. 9 is a flow chart of a method of operation of a communication system in an embodiment of the present invention.

### DETAILED DESCRIPTION

The following embodiments are described in sufficient detail to enable those skilled in the art to make and use the embodiments of the present invention. It is to be understood that other embodiments would be evident based on the present disclosure, and that system, process, or mechanical changes may be made without departing from the scope of the present invention.

The communication system can provide additional flexibility for managing unanswered calls by defining a range of response possibilities for the caller entry. The group management panel can configure the message options attributed to the established group in order to provide customizable options for the established group that include the notification options, the message options, and the scheduling options. By providing the scheduling options a better call back time, based on the user's calendar, a more efficient communication can take place.

In the following description, numerous specific details are given to provide a thorough understanding of the invention. However, it will be apparent that the invention may be practiced without these specific details. In order to avoid obscuring the embodiment of the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the embodiments of the present invention can be operated in any orientation.

Where multiple embodiments are disclosed and described having some features in common, for clarity and ease of illustration, description, and comprehension thereof, similar and like features one to another will ordinarily be described with similar reference numerals.

The term “processing” as used herein is defined as, as an example, managing incoming calls that can be intercepted by the voicemail system of the communication device. The term “provision” as used herein is defined as, as an example, the set-up of attributes and capabilities of a category of inbound calls identified by a source telephone number or caller identification (ID). It is understood that the definition of the term “provision” also extends to “provisioning” and “provisioned”. The term “soft key” means a software configured button for activating or responding to an application software, which can reside on a touch screen or a reconfigurable hard button.

The term “module” referred to herein can include software, hardware, or a combination thereof in the embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a micro-electromechanical system (MEMS), passive devices, or a combination thereof.

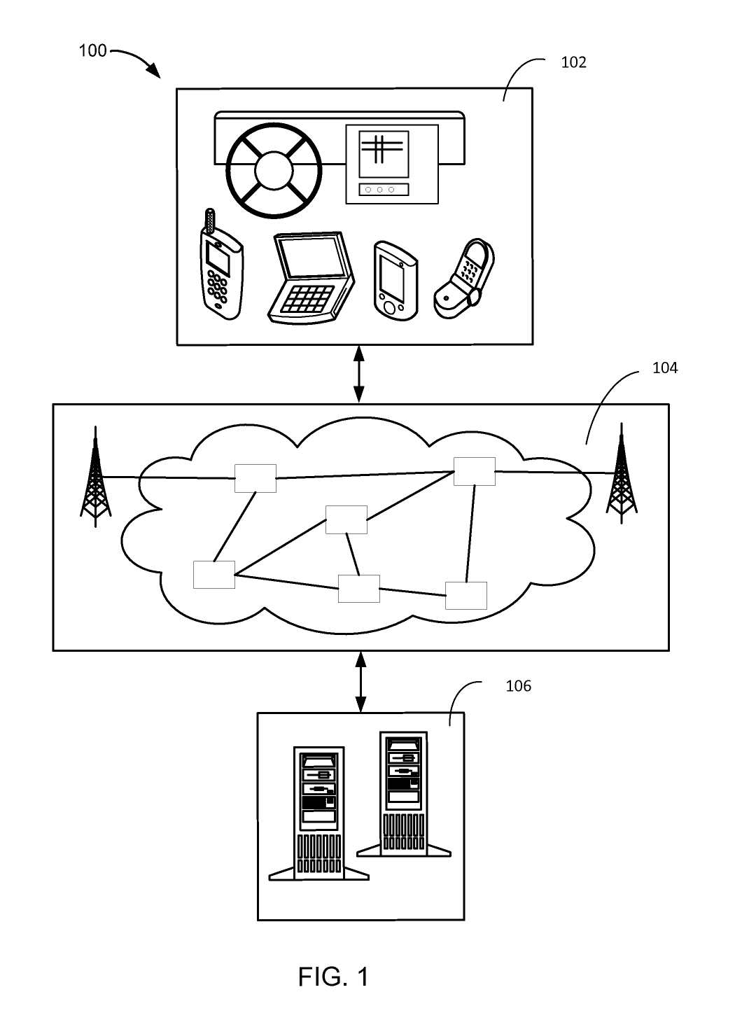

Referring now to FIG. 1, therein is shown an communication system 100 with call management mechanism in an embodiment of the present invention. The communication system 100 includes a first device 102, such as a client or a server, connected to a second device 106, such as a client or server, with a communication path 104, such as a wireless or wired network.

For example, the communication system 100 can include positioning systems that determine location using GPS, cell tower triangulation, cell sector identification, WiFi location, or any combination thereof. That communication system 100 can be any of a variety of location-based systems that can include automobile routing systems, personal navigation devices, marine navigation systems, aviation navigation systems, mapping systems, data logging systems, or any combination thereof.

In a further example, the first device 102 can be of any of a variety of mobile devices, such as a cellular phone, personal digital assistant, a notebook computer, automotive telematic navigation system, or other multi-functional mobile communication or entertainment device. The first device 102 can be a standalone device, or can be incorporated with a vehicle, for example a car, truck, bus, or train. The first device 102 can couple to the communication path 104 to communicate with the second device 106.

For illustrative purposes, the communication system 100 is described with the first device 102 as a mobile computing device, although it is understood that the first device 102 can be different types of computing devices. For example, the first device 102 can also be a non-mobile computing device, such as a server, a server farm, or a desktop computer.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102.

In another example, the first device 102 can be a particularized machine, such as a mainframe, a server, a cluster server, rack mounted server, or a blade server. Yet another example, the second device 106 can be a particularized machine, such as a portable computing device, a thin client, a notebook, a netbook, a smartphone, personal digital assistant, or a cellular phone.

For illustrative purposes, the communication system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example, a car, truck, bus, or train.

Also for illustrative purposes, the communication system 100 is shown with the second device 106 and the first device 102 as end points of the communication path 104, although it is understood that the communication system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

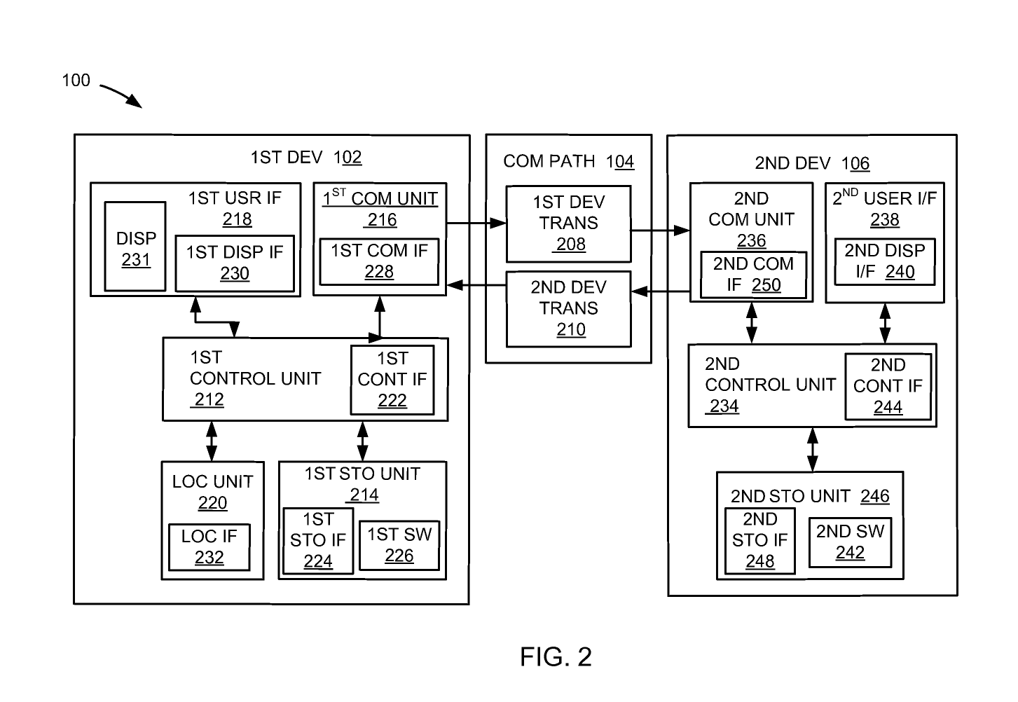

Referring now to FIG. 2, therein is shown an exemplary block diagram of the communication system 100 with call management mechanism in an embodiment of the present invention. The communication system 100 can include the first device 102, the communication path 104, and the second device 106.

The first device 102 can communicate with the second device 106 over the communication path 104. For example, the first device 102, the communication path 104, and the second device 106 can be the first device 102 of FIG. 1, the communication path 104 of FIG. 1, and the second device 106 of FIG. 1, respectively.

The first device 102 can send information in a first device transmission 208 over the communication path 104 to the second device 106. The second device 106 can send information in a second device transmission 210 over the communication path 104 to the first device 102.

For illustrative purposes, the communication system 100 is shown with the first device 102 as a client device, although it is understood that the communication system 100 can have the first device 102 as a different type of device. For example, the first device 102 can be a server.

Also for illustrative purposes, the communication system 100 is shown with the second device 106 as a server, although it is understood that the communication system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of the embodiment of the present invention.

The first device 102 can include a first control unit 212, a first storage unit 214, a first communication unit 216, a first user interface 218, and a location unit 220. The first device 102 can be any of a variety of mobile devices, such as a cellular phone, personal digital assistant, a notebook computer, automotive telematic navigation system, or other multi-functional mobile communication or entertainment device. The first device 102 can be a standalone device, or can be incorporated with a vehicle, for example a car, truck, bus, or train.

The first control unit 212 can include a first control interface 222. The first control unit 212 can be implemented in a number of different manners. For example, the first control unit 212 can be a processor, an embedded processor, a microprocessor, a hardware control logic, a hardware finite state machine (FSM), a digital signal processor (DSP), or a combination thereof.

The first control interface 222 can be implemented in different ways and can include different implementations depending on which functional units or external units are being interfaced with the first controller interface 222. For example, the first controller interface 222 can be implemented with a pressure sensor, an inertial sensor, a micro electro-mechanical system (MEMS), optical circuitry, waveguides, wireless circuitry, wireline circuitry, or a combination thereof.

The first storage unit 214 can include a first storage interface 224. The first storage unit 214 can be a volatile memory, a nonvolatile memory, an internal memory, an external memory, or a combination thereof. For example, the first storage unit 214 can be a nonvolatile storage such as non-volatile random access memory (NVRAM), Flash memory, disk storage, or a volatile storage such as static random access memory (SRAM).

The first storage interface 224 can be can be used for communication between the location unit 220 and other functional units in the first device 102. The first storage interface 224 can also be used for communication that is external to the first device 102.

The first storage interface 224 can receive information from the other functional units or from external sources, or can transmit information to the other functional units or to external destinations. The external sources and the external destinations refer to sources and destinations external to the first device 102. The first software interface 224 can be configured to compile a list of contacts that can be manipulated by the first control unit 212 in order to segregate specific groups that represent portions of the list of contacts.

The first storage interface 224 can include different implementations depending on which functional units or external units are being interfaced with the first storage unit 214. The first storage interface 224 can be implemented with technologies and techniques similar to the implementation of the first controller interface 222. A first software 226 can be stored in the first storage unit 214.

The first communication unit 216 can include a first communication interface 228. The first communication unit 216 can enable external communication to and from the first device 102. For example, the first communication unit 216 can permit the first device 102 to communicate with the second device 106, an attachment, such as a peripheral device or a computer desktop, and the communication path 104.

The first communication unit 216 can also function as a communication hub allowing the first device 102 to function as part of the communication path 104 and not limited to be an end point or terminal unit to the communication path 104. The first communication unit 216 can include active and passive components, such as microelectronics or an antenna, for interaction with the communication path 104.

The first communication interface 228 can be used for communication between the first communication unit 216 and other functional units in the first device 102. The first communication interface 228 can receive information from the other functional units or can transmit information to the other functional units.

The first communication interface 228 can include different implementations depending on which functional units are being interfaced with the first communication unit 216. The first communication interface 228 can be implemented with technologies and techniques similar to the implementation of the first controller interface 222.

The first user interface 218 can include a first display interface 230. The first user interface 218 can include an input device and an output device. Examples of the input device of the first user interface 218 can include a keypad, a touchpad, soft-keys, a keyboard, a microphone, or any combination thereof to provide data and communication inputs. Examples of the output device of the first user interface 218 can include the first display interface 230. The first display interface 230 can include a display device 231. Examples of the display device 231 can include a projector, a video screen, a speaker, a touch screen, or any combination thereof.

The location unit 220 can include a location interface 232. The location unit 220 can be implemented in many ways. For example, the location unit 220 can function as at least a part of a global positioning system (GPS), an inertial navigation system, a cellular-tower location system, a pressure location system, or any combination thereof.

The location interface 232 can be used for communication between the location unit 220 and other functional units in the first device 102. The location interface 232 can also be used for communication that is external to the first device 102.

The location interface 232 can receive information from the other functional units or from external sources, or can transmit information to the other functional units or to external destinations. The external sources and the external destinations refer to sources and destinations external to the first device 102.

The location interface 232 can include different implementations depending on which functional units or external units are being interfaced with the location unit 220. The location interface 232 can be implemented with technologies and techniques similar to the implementation of the first controller interface 222.

The second device 106 can be optimized for implementing the embodiment of the present invention in a multiple device embodiment with the first device 102. The second device 106 can provide the additional or higher performance processing power compared to the first device 202. The second device 106 can include a second control unit 234, a second communication unit 236, and a second user interface 238.

The second user interface 238 allows a user (not shown) to interface and interact with the second device 206. The second user interface 238 can include an input device and an output device. Examples of the input device of the second user interface 238 can include a keypad, a touchpad, soft-keys, a keyboard, a microphone, or any combination thereof to provide data and communication inputs. Examples of the output device of the second user interface 238 can include a second display interface 240. The second display interface 240 can include a display, a projector, a video screen, a speaker, or any combination thereof.

The second control unit 234 can execute a second software 242 to provide the intelligence of the second device 106 of the communication system 200. The second software 242 can operate in conjunction with the first software 226. The second control unit 234 can provide additional performance compared to the first control unit 212.

The second control unit 234 can operate the second user interface 238 to display information. The second control unit 234 can also execute the second software 242 for the other functions of the communication system 100, including operating the second communication unit 236 to communicate with the first device 102 over the communication path 104.

The second control unit 234 can be implemented in a number of different manners. For example, the second control unit 234 can be a processor, an embedded processor, a microprocessor, a hardware control logic, a hardware finite state machine (FSM), a digital signal processor (DSP), or a combination thereof.

The second control unit 234 can include a second controller interface 244. The second controller interface 244 can be used for communication between the second control unit 234 and other functional units in the second device 106. The second controller interface 244 can also be used for communication that is external to the second device 106.

The second controller interface 244 can receive information from the other functional units or from external sources, or can transmit information to the other functional units or to external destinations. The external sources and the external destinations refer to sources and destinations external to the second device 106.

The second controller interface 244 can be implemented in different ways and can include different implementations depending on which functional units or external units are being interfaced with the second controller interface 244. For example, the second controller interface 244 can be implemented with a pressure sensor, an inertial sensor, a micro electro-mechanical system (MEMS), optical circuitry, waveguides, wireless circuitry, wireline circuitry, or a combination thereof.

A second storage unit 246 can store the second software 242. The second storage unit 246 can also store the relevant information, such as contact lists, caller identifications, established groups, recorded messages, response options, or any combination thereof. The second storage unit 246 can be sized to provide the additional storage capacity to supplement the first storage unit 214.

For illustrative purposes, the second storage unit 246 is shown as a single element, although it is understood that the second storage unit 246 can be a distribution of storage elements. Also for illustrative purposes, the communication system 100 is shown with the second storage unit 246 as a single hierarchy storage system, although it is understood that the navigation system 100 can have the second storage unit 246 in a different configuration. For example, the second storage unit 246 can be formed with different storage technologies forming a memory hierarchal system including different levels of caching, main memory, rotating media, or off-line storage.

The second storage unit 246 can be a volatile memory, a nonvolatile memory, an internal memory, an external memory, or a combination thereof. For example, the second storage unit 246 can be a nonvolatile storage such as non-volatile random access memory (NVRAM), Flash memory, disk storage, or a volatile storage such as static random access memory (SRAM).

The second storage unit 246 can include a second storage interface 248. The second storage interface 248 can be used for communication between the second control unit 234 and other functional units in the second device 106. The second storage interface 248 can also be used for communication that is external to the second device 106.

The second storage interface 248 can receive information from the other functional units or from external sources, or can transmit information to the other functional units or to external destinations. The external sources and the external destinations refer to sources and destinations external to the second device 106.

The second storage interface 248 can include different implementations depending on which functional units or external units are being interfaced with the second storage unit 246. The second storage interface 248 can be implemented with technologies and techniques similar to the implementation of the second controller interface 244.

The second communication unit 236 can enable external communication to and from the second device 206. For example, the second communication unit 236 can permit the second device 106 to communicate with the first device 102 over the communication path 104.

The second communication unit 236 can also function as a communication hub allowing the second device 106 to function as part of the communication path 104 and not limited to be an end point or terminal unit to the communication path 104. The second communication unit 236 can include active and passive components, such as microelectronics or an antenna, for interaction with the communication path 104.

The second communication unit 236 can include a second communication interface 250. The second communication interface 250 can be used for communication between the second communication unit 236 and other functional units in the second device 106. The second communication interface 250 can receive information from the other functional units or can transmit information to the other functional units.

The second communication interface 250 can include different implementations depending on which functional units are being interfaced with the second communication unit 236. The second communication interface 250 can be implemented with technologies and techniques similar to the implementation of the second controller interface 244.

The first communication unit 216 can couple with the communication path 104 to send information to the second device 106 in the first device transmission 208. The second device 106 can receive information in the second communication unit 236 from the first device transmission 208 of the communication path 104.

The second communication unit 236 can couple with the communication path 104 to send information to the first device 102 in the second device transmission 210. The first device 102 can receive information in the first communication unit 216 from the second device transmission 210 of the communication path 104. The communication system 200 can be executed by the first control unit 212, the second control unit 234, or a combination thereof.

For illustrative purposes, the second device 106 is shown with the partition having the second user interface 238, the second storage unit 246, the second control unit 234, and the second communication unit 236, although it is understood that the second device 106 can have a different partition. For example, the second software 242 can be partitioned differently such that some or all of its function can be in the second control unit 234 and the second communication unit 236. In addition, the second device 106 can include other functional units not shown in FIG. 2 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the communication system 100 is described by operation of the first device 102 and the second device 106. It is understood that the first device 102 and the second device 106 can operate any of the modules and functions of the communication system 100. For example, the first device 102 is described to operate the location unit 220, although it is understood that the second device 106 can also operate the location unit 220.

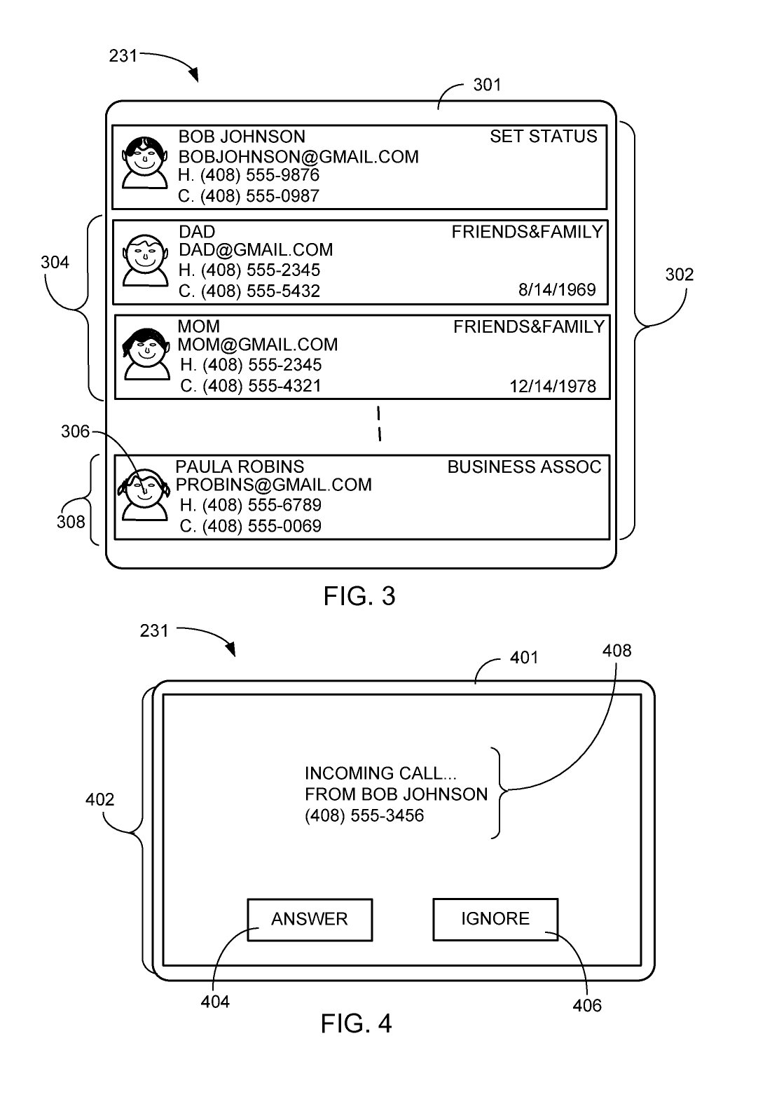

Referring now to FIG. 3, therein is shown an example of the display device 231 having a contact list panel 301. The contact list panel 301 depicts a segment of a contact list 302 for the first device 102 of FIG. 1 as viewed on the display device 231 coupled to the first display interface 230 of FIG. 2. The contact list 302 can be organized by the control unit 212 of FIG. 2 to include an established group 304 assembled from a portion of the contact list 302 and can catalog individual information for all of the caller entry 306 that are maintained by the user of the communication system 100 of FIG. 1.

The established group 304 can be assembled from the entries of the contact list 302 for the purpose of defining permissions for an individual record 308 of the contact list 302 and any number of the established group 304 can be assembled within the contact list 302. It is understood that each of the caller entry 306 in the contact list 302 represents a person or entity that is associated with the user of the communication system 100. It is further understood that the caller entry 306 can be from a source that is not in the contact list 302 but could be added at a later time, such as a new business associate, an unknown solicitor, or a new personal contact.

The individual record 308 of the contact list 302 can include the name of the caller entry 306, a contact e-mail address, contact telephone numbers, their affiliation to the established group 304 and any additional personal information, such as a date of birth, and anniversary date, venue of initial contact, or the like. The individual record 308 can be submitted to the contact list 302 in the form of a business card without having an affiliation to the established group 304. In such cases, the record can be accepted into the contact list 302 and allow the affiliation to a selected one of the established group 304 to occur at a later time.

Referring now to FIG. 4, therein is shown an example of the display device 231 having an incoming call display 401. The incoming call display 401, of the display device 231 which is coupled to the first display interface 230 of FIG. 2, includes an announcement screen 402 for displaying the telephone number and caller ID information of the caller entry 306 of FIG. 3. The announcement screen 402 can include an answer button 404 and an ignore button 406, which are configured as soft keys in the display device 231. The answer button 404 can connect the caller entry 306 for an immediate conversation. The ignore button 406 can activate a response configured for managing the incoming call based on the established group 304 of FIG. 3. The incoming call can also be ignored by failing to activate the answer button 404 and the ignore button 406 within a time limit that can be defined for the established group 304.

It is understood that the configuration of the announcement screen 402 in the display device 231 is an example only and that other configurations are possible. It is further understood that an incoming banner 408 can be a display generated by combining caller ID information from the incoming call with information from the contact list 302 of FIG. 3.

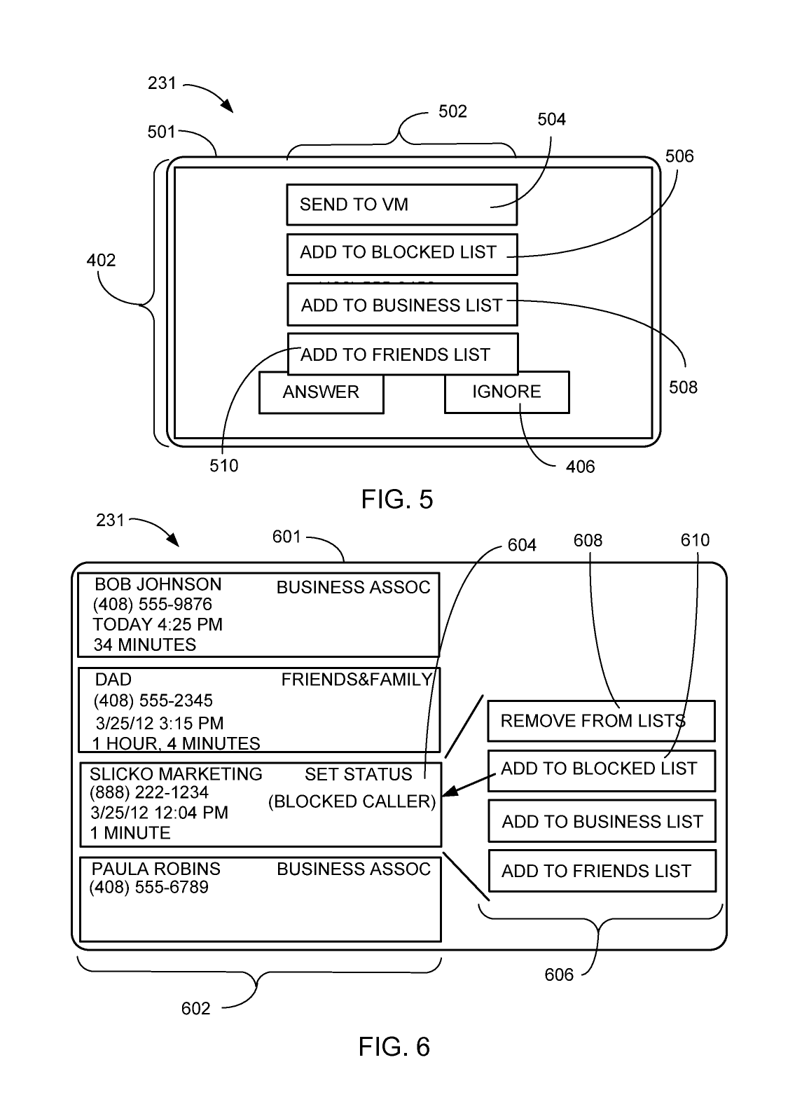

Referring now to FIG. 5, therein is shown an example of the display device 231 having an option overlay panel 501 accessed through the incoming call display 401 of FIG. 4. The option overlay panel 501 is accessed by actuating the ignore button 406 of the announcement screen 402. Option buttons 502 can appear over or partially blocking the telephone number and caller ID information of the caller entry 306 of FIG. 3 on the announcement screen 402.

The option buttons 502 can appear immediately after the ignore button 406 is actuated. If no other action is taken the default operation will occur after a two second delay to execute a predefined response based on the established group 304 of FIG. 3.

An activate voicemail button 504 can send the caller entry 306 to a voice mailbox in order to leave a voice mail message. If one of the option buttons 502 is actuated, the action is immediate. The activate voicemail button 504 will direct the caller entry 306 to the voice mailbox without regard to the identity of the caller entry 306. An activate blocked button 506 will initialize the caller entry 306 as a blocked number with a first occurrence. A reply will be issued to the caller entry 306 indicating “the number is not available”.

An activate business list button 508 activates the provisions defined for the established group 304 affiliated with business associates. The options can include connecting to voicemail, leaving a call-back number, scheduling a call-back appointment, flagging an urgent call, or a combination thereof.

An activate friends list button 510 activates the provisions defined for the established group 304 affiliated with friends and family. The options can include connecting to voicemail, leaving a call-back number, scheduling a call-back appointment, flagging an urgent call, or a combination thereof.

Referring now to FIG. 6, therein is shown an example of the display device 231 having a call log overlay 601 for processing a call log 602. The call log 602 compiles a list of all of the calls processed by the first device 102 of FIG. 1. When the caller entry 306 of FIG. 3 is affiliated with one of the established groups 304, that affiliation is listed in the call log 602. If the caller entry 306 is not affiliated with one of the established groups 304 a log entry 604 will indicate “set status”. By actuating the set status entry an options overlay 606 can be displayed for the log entry 604.

The options overlay 606 can include a remove from lists button 608 and a blocked caller 610 can be identified by actuating a blocked caller button. The remove from lists button 608 can eradicate the log entry 604 from the call log 602. The blocked caller 610 can add the caller entry 306 to the established group 304 of blocked callers 610 and activate the provisions defined for the established group 304 of blocked callers 610. On the next occurrence of a call from the same blocked caller can respond differently for each successive call from the blocked caller 610. On the second occurrence of the incoming call from the blocked caller 610, the communication system 100 of FIG. 1 will automatically initiate an outgoing message that simply states “The person you are trying to reach is not available. Goodbye.” On the third occurrence of a call from the blocked caller 610 can activate a custom message such as “The person does not accept calls from this number. Please do not call back.” Any subsequent calls from the blocked caller 610 can activate a fake “modem sound” to confuse the caller, sound of a car crash, an ear-shattering screech, or other noise to discourage them from ever calling back!

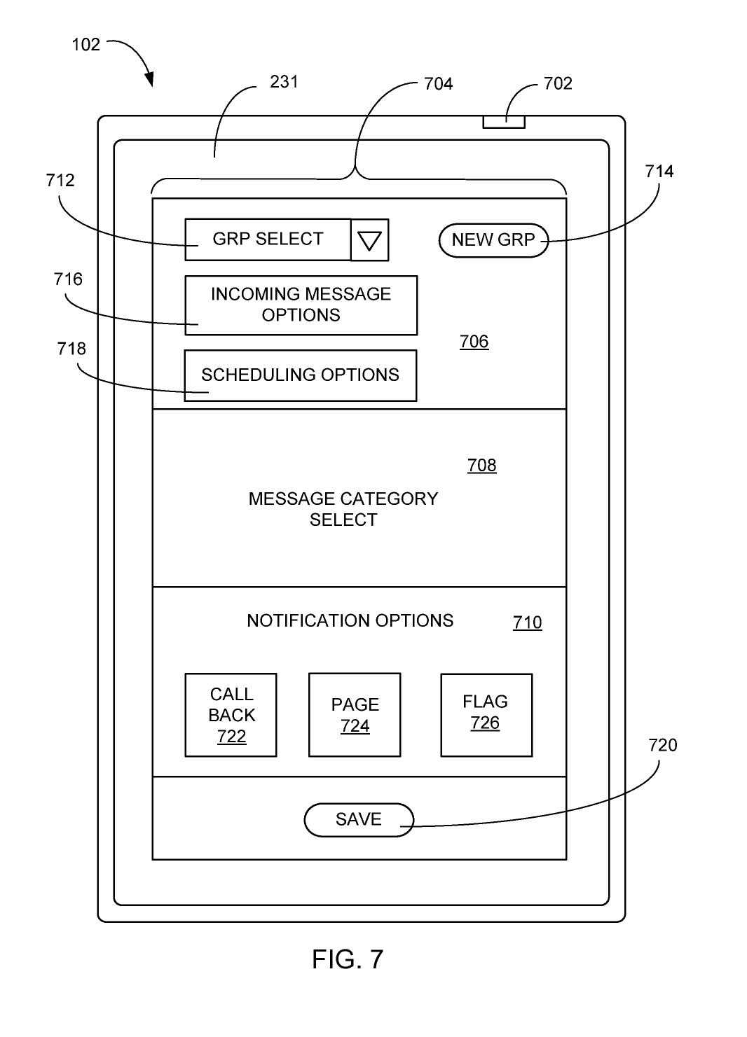

Referring now to FIG. 7, therein is shown an example of the first device 102, having the display device 231, in a response configuration process. The display device 231 can represent the screen shot for the response configuration process. A light emitting diode (LED) 702 can be configured in the first device 102 for alerting the user to certain conditions. The display device 231 can show a graphical user interface 704 of the first device 102. The graphical user interface 704 includes a group management panel 706, an outgoing message panel 708, and notification options 710.

The group management panel 706 includes a group select pull-down 712. The group select pull-down 712 allows the established group 304 of FIG. 3 to be provisioned as to how incoming calls can be managed by the first device 102. The group select pull-down 712 can enable provisioning a friends and family group, a business associate group, a blocked caller group, and a special group. A new group key 714 can be used to provision a new version of the established group 304. The established group 304 is defined to be a category of callers that share a common set of attributes or a special theme.

The established groups 304 can include business associates, friends and family, blocked callers 610 of FIG. 6, or any special group defined through the group management panel 706. It is understood that a special group can include an individual caller in order to convey a personal message that is intended for only the individual caller of the special group. It is further understood that there is no practical limit to the number of the established groups 304 that can be provisioned within the first device 102 and thus any number of the established groups 304 can be provisioned as defined by the embodiment of the present invention.

The group management panel 706 can provide message options 716 attributed to the established group 304 selected in the group select pull-down 712. The message options 716 can establish a time-out limit for ignoring an incoming call as provisioned for the established group 304, allow callers to leave a voice mail message, leave a call-back number, send a page, or a combination thereof. The message options 716 can provide a checkbox structure that allows the user of the communication system 100 to customize the response possibilities attributed to the established group 304 that was selected. It is understood that the message options 716 can include leaving a video message or activating a call-back trigger.

Scheduling options 718, of the group management panel 706, can provide access to a personal calendar in order to establish an alternate time for the call to be completed. The scheduling options 718 can selectively provide an interactive calendar option that allows the caller to interrogate a calendar in order to select a call-back time. The interactive calendar option can be enabled, to add a call-back appointment to the calendar, send a text message announcing the appointment, send a text reminder of the call-back appointment, or a combination thereof, for the established group 304.

The outgoing message panel 708 can be configured to provide a personal message, recorded by the user of the first device 102, a professional message provided by the communication system 100 using the recorded name of the user, a generic message, or a blocked caller message, which can be customized to act as a deterrent to harassing calls from a blocked caller 610. The outgoing message panel 708 can provide a review button that allows the user of the communication system 100 to listen to the messages that will be presented to callers that are included in the established group 304 that is selected in the group select pull-down 712.

The notification options 710 can be enabled if the established group 304 that is selected from the group select pull-down 712 is provided with the option to flag the call as an urgent call. The notification options 710 can include activating a vibration, a sound effect, a blinking of the light emitting diode (LED) 702, sending a text message, or a combination thereof. The notification options 710 can assert a vibration which can be customized to establish the frequency, duration of the vibration, repeat period of the vibration, such as between 2 seconds and 5 minutes, or a combination thereof. The notification options 710 can provide the sound effect which can be customized for the established group 304 that is selected from the group select pull-down 712.

The sound effect can be used to rapidly identify the urgent call from a specific one of the established groups 304. The blinking of the light emitting diode (LED) 702 can be customized to establish the duration of illumination, repeat period of the illumination, such as between 2 seconds and 5 minutes, or a combination thereof. The text message can be customized to indicate the established group 304, the caller ID of the specific caller within the established group 304, the time of the urgent call, the duration of the urgent call, whether voicemail was left for the urgent call, or a combination thereof.

A save button 720 can be used to store the selected options and actions attributed to the established group 304 that is selected from the group select pull-down 712. Thus all of the actions and options available can be initiated or updated through the graphical user interface 704.

The notification options 710 can include function select buttons for a call-back 722, a page 724, or a flag as urgent 726. The function select for the call-back 722 includes configuring the established group 304 for leaving a call-back number, establishing an optimum time, and determining a reminder process such as sending a text message, sounding a tone, starting a vibration, blinking the LED 702, or a combination thereof. The function select for the page 724 includes allowing a page to be sent, establishing a tone, configuring a vibration, configuring a pattern for blinking the LED 702, or a combination thereof. The function select for the flag as urgent 726 includes allowing the established group 304 to activate the flag as urgent 726 and establishing a set urgent notifications that over-rides the tone, vibration, and blinking LED established by the page 724. It is understood that any of the established group 304 can be configured to allow the call-back 722, the page, or the flag as urgent 726 in any combination and each combination can be differentiated to identify the specific one of the established group 304 that is utilizing the function.

It is understood that the provisioning for the established group 304 that is selected from the group select pull-down 712 can be stored by the first device 102 or the second device 106 of FIG. 1. It is further understood that the graphical user interface 704 does not have to be accessed by or on the first device 102 and can also be accessed by operating the second device 106 through the network 104. It is further understood that both the first device 102 and the second device 106 can have security options to secure the settings established for the established groups 304 associated with the first device 102.

It has been discovered that the communication system 100 can provide additional flexibility for managing unanswered calls by defining a range of response possibilities for the caller entry 306 of FIG. 3. The group management panel 706 can configure the message options 716 attributed to the established group 304 in order to provide customizable options for the established group 304 that include the notification options 710, the message options 716, and the scheduling options 718. By providing the scheduling options 718 a better call back time, based on the user's calendar, a more efficient communication can take place.

Thus, it has been discovered that the communication system 100 and device 102 of the embodiment of the present invention furnishes important and heretofore unknown and unavailable solutions, capabilities, and functional aspects for managing incoming calls.

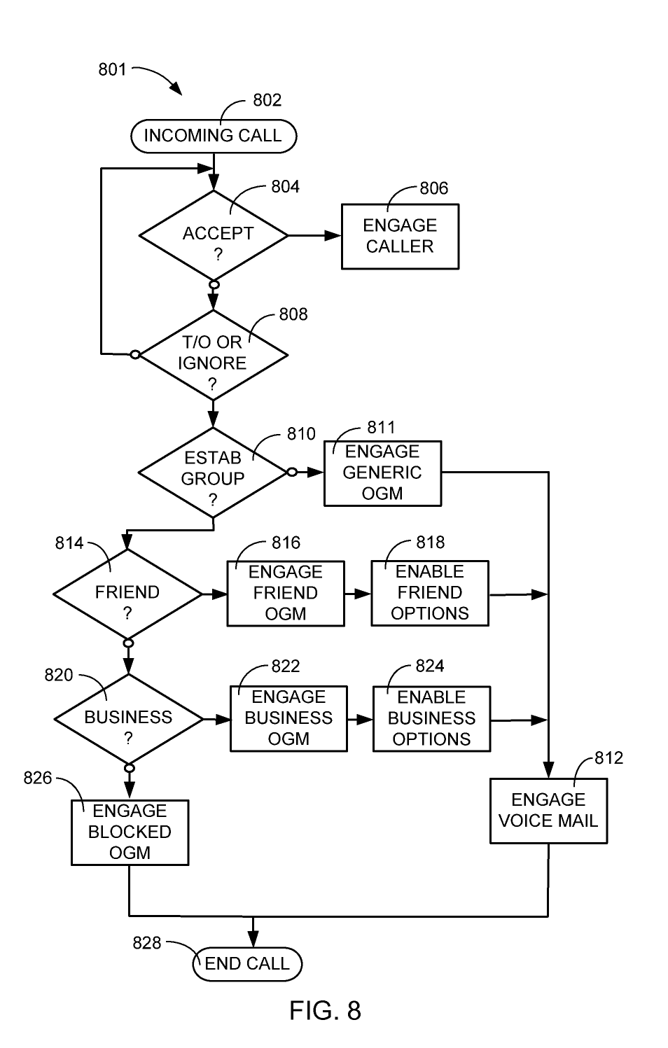

Referring now to FIG. 8, therein is shown a flow chart of an exemplary method 801 of operation of the communication system 100 of FIG. 1. The flow chart of the exemplary method 801 depicts an incoming call 802 to the communication system 100. The flow proceeds to an accept module 804, which determines whether the answer button 404 of FIG. 4 has been activated. If the answer button 404 has been activated, the flow proceeds to an engage caller module 806. The engage caller module 806 provides a direct dialog through the communication system 100.

If it is detected that the answer button has not been activated, the flow proceeds to a check unattended module 808. The check unattended module 808 checks for activation of the ignore button 406 of FIG. 4 or a time-out of preset timer within the first control unit 212 of FIG. 2. The preset timer can count down a number of seconds that are defined by the message options 716 of FIG. 7, such as two seconds, from the receipt of the incoming call 802. If the check unattended module 808 is not activated, the flow returns to the accept module 804 to once again determine if the answer button 404 has been activated,

If the check unattended module 808 determines that the ignore button 406 has been activated or the preset timer of the first control unit 212 has timed-out, the flow proceeds to a check for established group 810 to determine if the incoming call 802 was originated from a number represented in the established group 304 of FIG. 3. The check for established group 810 can search the contact list 302 of FIG. 3 to locate the number of the incoming call 802. If the number of the incoming call 802 is not found in the contact list 302, the flow proceeds to an engage generic outgoing message 811.

In the engage generic outgoing message 811, an appropriate outgoing message can include a pre-recorded message or a synthesized message is sent to the originator of the incoming call 802. The flow then proceeds to an engage voice mail 812 in order to record the response of the originator of the incoming call 802. The engage voicemail 812 can perform other operations as configured in the message options 716 of FIG. 7.

If the check for established group 810 determines that the originating number of the incoming call 802 is in the contact list 302, the flow proceeds to a check for friends and family 814. If the check for friends and family 814 determines that the originating number of the incoming call 802 is in the established group 304 reserved for friends and family, the flow proceeds to an engage friends outgoing message 816, in which a personal greeting can be sent to the originating number of the incoming call 802. The flow then proceeds to an enable friend options 818.

The enable friend options 818 can allow the incoming call 802 to be flagged as urgent, provide suggested call-back times, or provide alternate contact means. The enable friend options 818 can also a range of responses allowed for the incoming call 802. The allowable responses for the incoming call 802 can include an option list providing a series of one button responses, the option to engage an emergency ring tone, engage a vibration, leave a voice mail, or a combination thereof. The flow then proceeds to the engage voice mail 812 to receive any response from the incoming call 802.

If it is determined that the originating number of the incoming call 802 is not among the established group 304 reserved for friends and family, the flow proceeds to a check for business associate 820. The check for business associate 820 can search the established group 304 reserved for business associates to determine whether the incoming call 802 is from a business associate. If it is determined that the incoming call 802 is from a business associate, the flow proceeds to an business outgoing message 822. The business outgoing message 822 can enable a personal business outgoing message or a synthesized business outgoing message to be sent to the incoming call 802.

The flow then proceeds to an enable business options 824, in which the incoming call can be offered other alternative times for completing the incoming call 803. An option can enable the originator of the incoming call 802 to access a calendar in order to set an appointment to complete the incoming call. If the appointment is entered in the calendar, the enable business options 824 can send alerts via text messages, e-mail, coded vibrations, or special ring tones as configured for the established group 304 reserved for business associates. The configuration of the actions of the enable business options 824 can be established when the established group is created or it can be edited at a later time. The flow then proceeds to the engage voice mail 812 to receive any response from the incoming call 802.

If the check for business associate 820 determines that the incoming call 802 is not from a business associate, any other of the established group 304 can be checked. For brevity the flow assumes there are no other categories of the established group 304. Since other possibilities have been ruled out the number can be assumed to be from the blocked caller group. As such, the flow proceeds to a blocked caller outgoing message 826. The blocked caller outgoing message 826 can determine whether this is a second or greater number of occurrences of the incoming call 802 from the number in the blocked caller group 610 of FIG. 6. A synthesized version of the blocked caller outgoing message 826 can be provided with an escalating degree of rudeness in order to deter the repeated access by the originator of the incoming call 802. The flow will terminate at an end call module 828 to complete the processing of the incoming call 802.

The number of the established groups 304 has been limited in order to simplify the description of the operation of the exemplary method 801 of operation of the communication system 100. It is understood that any number of the established group 304, each having a different one of the outgoing message 811 and the notification option 710 of FIG. 7, can be defined. Any special group can be established having at least a single instance of the individual record 308 of FIG. 3. By creating the established group 304 having the single instance of the individual record 308 a personal or confidential message can be delivered as the outgoing message intended for solely the individual record 308 and response options can include any of the options listed above.

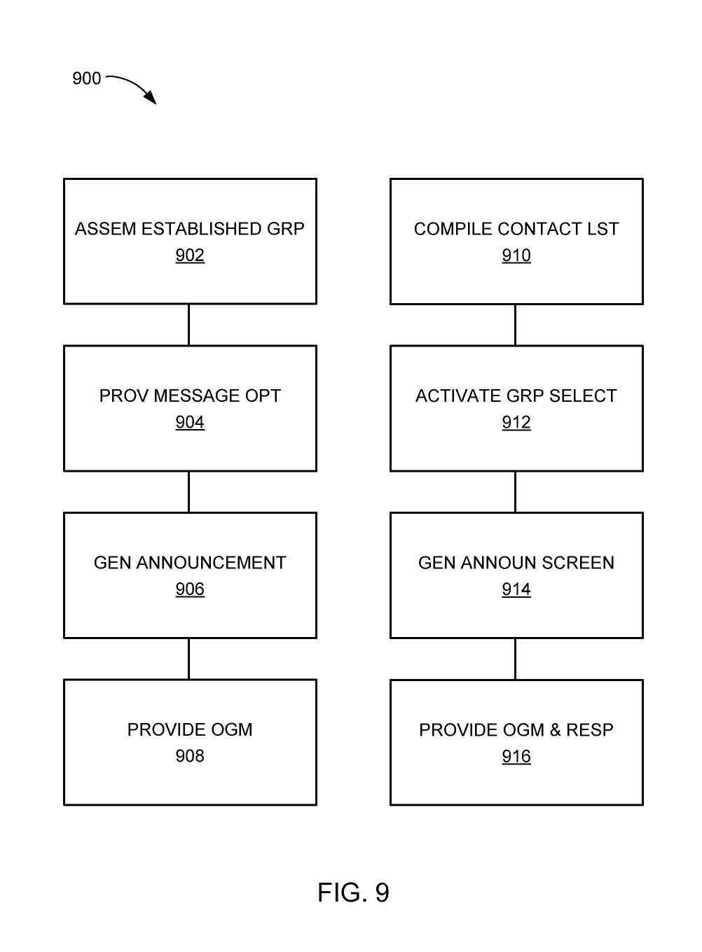

Referring now to FIG. 9, therein is shown a flow chart of a method 900 of operation of an communication system in a further embodiment of the present invention. The method 900 includes: assembling an established group with a control unit in a block 902; provisioning a message option attributed to the established group in a block 904; generating an announcement screen for displaying on a display device in a block 906; and providing an outgoing message and response option, by ignoring the announcement screen, based on the message option attributed to the established group in a block 908.

The communication system can provide additional flexibility for managing unanswered calls by defining a range of response possibilities attributed to the established group for the caller entry. The group management panel can configure the message options attributed to the established group in order to provide customizable options for the established group that include the notification options, the message options, and the scheduling options. By providing the scheduling options a better call back time, based on the user's calendar, a more efficient communication can take place.

The method 900 includes: assembling an established group with a control unit including compiling a contact list for determining the established group in a block 910; provisioning a message option attributed to the established group including activating a group select pull-down for designating the contact list as one of blocked, business associates, special, and friends in a block 912; generating an announcement screen for displaying on a display device in a block 914; and providing an outgoing message and a response option, by ignoring the announcement screen, based on the message option attributed to the established group in a block 916.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the embodiment of the present invention is that it valuably supports and services the historical trend of reducing costs, simplifying systems, and increasing performance. These and other valuable aspects of the embodiment of the present invention consequently further the state of the technology to at least the next level.

While the embodiment of the present invention has been described in conjunction with a specific best mode, it is to be understood that many alternatives, modifications, and variations will be apparent to those skilled in the art in light of the previous description. Accordingly, it is intended to embrace all such alternatives, modifications, and variations that fall within the scope of the included claims. All matters that are set forth herein or shown in the accompanying drawings are to be interpreted in an illustrative and non-limiting sense.

What is claimed is:

1. A communication system comprising:
a control unit configured to assemble an established group;
a storage unit, coupled to the control unit, configured to store a message option attributed to the established group;
a display interface, coupled to the control unit, configured to generate an announcement screen displayed on a display device; and
a communication unit coupled to the control unit, configured to provide an outgoing message and response option based on the message option attributed to the established group.

2. The system as claimed in claim 1 wherein the storage unit includes a storage interface configured to access a value of a timeout for an incoming call based on the message option of the established group.

3. The system as claimed in claim 1 wherein the control unit is configured to determine the established group is a business associate includes a business outgoing message is transferred to the communication unit.

4. The system as claimed in claim 1 further comprising a user interface, coupled to the control unit, is configured to generate a sound effect based on the notification option of the established group.

5. The system as claimed in claim 1 wherein the display interface is configured to display a button to designate a blocked caller in the announcement screen.

6. A method for managing communication comprising:
assembling an established group using a control unit;
provisioning a message option attributed to the established group;
generating an announcement screen for displaying on a display device; and
providing an outgoing message and a response option, by ignoring the announcement screen, based on the message option attributed to the established group.

7. The method as claimed in claim 6 wherein provisioning the message option includes provisioning a timeout, based on the established group, for ignoring an incoming call.

8. The method as claimed in claim 6 further comprising determining a check for business associate for enabling a business outgoing message attributed to the established group.

9. The method as claimed in claim 6 further comprising provisioning a notification option, based on the established group, for generating a sound effect.

10. The method as claimed in claim 6 further comprising recognizing an incoming call from a blocked caller in response to the announcement screen.

11. The method as claimed in claim 6 wherein assembling the established group includes compiling a contact list for determining the established group, and wherein provisioning the message includes activating a group select pull-down for designating the contact list as one of blocked, business associates, special, and friends.

12. The method as claimed in claim 11 wherein provisioning the message option includes provisioning a timeout, based on the established group, for ignoring an incoming call including leaving a voice mail, entering a call-back number, sending a page, flagging as urgent, or a combination thereof as provisioned for the established group.

13. The method as claimed in claim 11 further comprising determining a check for business associate for enabling a business outgoing message attributed to the established group including leaving a voice mail, scheduling a call-back time, entering a call-back number, sending a page, flagging as urgent, or a combination thereof as provisioned for the established group.

14. The method as claimed in claim 11 further comprising provisioning a notification option, based on the established group, for generating a sound effect, a vibration, blinking a light emitting diode, sending a text message, or a combination thereof.

15. The method as claimed in claim 11 further comprising recognizing an incoming call from a blocked caller in response to the announcement screen including responding differently for each successive call from a log entry designated as the blocked caller.

16. The system as claimed in claim 1 wherein the storage unit includes a software interface configured to compile a contact list and determine the established group.

17. The system as claimed in claim 16 wherein the storage unit includes a storage interface configured to access a value of a timeout for an incoming call based on the message option of the established group wherein the message option can allow the incoming call to leave a voicemail, enter a call-back number, send a page, flag as urgent, or a combination thereof.

18. The system as claimed in claim 16 wherein the control unit, is configured to determine the established group as a business associate, is coupled to the communication unit to transfer a business outgoing message.

19. The system as claimed in claim 16 further comprising a user interface, coupled to the control unit, is configured to generate a sound effect, a vibration, a text message, illuminate a light emitting diode, or a combination thereof based on the notification option of the established group.

20. The system as claimed in claim 16 wherein the control unit is coupled to the display interface, configured to display a button to designate a blocked caller in the announcement screen, and the storage unit configured to retrieve a different instance of a blocked outgoing message for each successive call from a log entry designated as the blocked caller.

21. A graphical user interface of a communication system, the graphical user interface produced by and displayed on a display device of the communication system, comprising:
a group management panel having a group select pull-down configured to select one of a polarity of an established group, wherein the established group represents a portion of a contact list;
an outgoing message panel adjacent to the group management panel configured to associate an outgoing message defined for the established group selected by the group select pull-down; and
notification options adjacent to the outgoing message panel configured to provision possible responses to the outgoing message including a call-back, send a page, flag as urgent, or a combination thereof, defined for the established group selected by the group select pull-down.

22. The graphical user interface of claim 21 further comprising an incoming banner configured to display a caller entry of the incoming call with an indication of the established group selected by the group select pull-down.

23. The graphical user interface of claim 21 further comprising an individual record, of the contact list, selected as a member of the established group by the group select pull-down.

24. The graphical user interface of claim 21 wherein the established group includes a log entry, of a call log, attributed to the established group by an options overlay.
